(19) United States
(12) Patent Application Publication
(10) Pub. No.: US 2006/0244599 A1
(43) Pub. Date: Nov. 2, 2006

(54) Identification apparatus

(75) Inventors: Carl E. Taylor, Pittsburgh, PA (US); Charles Greene, Pittsburgh, PA (US); Muhammad R. Rahim, Monroeville, PA (US)

Correspondence Address: THE WEBB LAW FIRM, P.C., 700 KOPPERS BUILDING, 436 SEVENTH AVENUE, PITTSBURGH, PA, 15219, US

(73) Assignee: Mobile Aspects, Inc., Pittsburgh, PA (US)

(21) Appl. No.: 11/397,340

(22) Filed: Apr. 3, 2006

Related U.S. Application Data
(63) Continuation-in-part of application No. 10/691,082, filed on Oct. 22, 2003, now abandoned.

(51) Int. Cl. G08B 13/14

(52) U.S. Cl. 340/572.1

(57) ABSTRACT

An identification apparatus for use in connection with a plurality of discrete identity source elements positioned in an identification apparatus signal identification area. The identification apparatus includes a plurality of signal receiving mechanisms forming a first signal receiving module and each of the signal receiving mechanisms having a respective field of detection, each of which comprises at least a portion of the identification apparatus signal identification area and at least partially overlaps another field of detection. Each signal receiving mechanism is individually powered in a specified pattern, and the first signal receiving module moves along an axis of movement. A control mechanism in communication with the signal receiving module.

### CROSS REFERENCE TO RELATED APPLICATIONS

This application is a continuation-in-part and claims the benefit of priority from U.S. patent application Ser. No. 10/691,082, filed Oct. 22, 2003, which is incorporated herein by reference in its entirety.

### BACKGROUND OF THE INVENTION

1. Field of the Invention

The present invention relates generally to identification apparatus and devices for gathering data regarding a plurality of objects or items and, in particular, to an identification apparatus that is useful in identifying stationary objects, items, tags and the like regardless of orientation.

2. Description of Related Art

In order to track and gather data regarding objects, such as items, products, individuals, cars, etc., radio frequency (RF) identification technology allows for the accurate tracking of the objects in the system. Typically, the object or objects will have an identification source or tag associated therewith, and this tag provides a unique identification to the object or individual. A receiving unit, typically in the form of an antenna, interacts with the tags and receives signals for further processing. After the signal is received, a control mechanism or other device processes the signal and identifies the object or individual based upon the signal content and source tag.

In many radio frequency identification (RF/ID) applications, a stationary antenna or receiver is used in connection with a moving object. For example, if items are moving along a conveyor belt, they are positioned such that they move past the antenna for identification. Similarly, an appropriately tagged car may drive by an antenna on a toll road. In these examples, the tag or identification source is moving, while the receiver or antenna is stationary.

However, problems arise when the tagged objects are static or stationary. In these situations, the object, and therefore the tag, may be positioned in an orientation that is unfavorable or detrimental to the RF/ID powering and communicating process. These inappropriately oriented tags have a low probability of being identified by the reader or antenna, which causes errors and other malfunctions in the system.

### SUMMARY OF THE INVENTION

It is, therefore, an object of the present invention to provide an identification apparatus that overcomes the deficiencies of the prior art. It is another object of the present invention to provide an identification apparatus that is useful in identifying stationary objects. It is a still further object of the present invention to provide an identification apparatus that is able to receive information from an object regardless of its position.

The present invention is an identification apparatus for use in connection with multiple discrete identity source elements that are positioned in an identification apparatus signal identification area. The identification apparatus includes at least one signal receiving mechanism for receiving a signal emitted from the identity source elements. This signal receiving mechanism has a field of detection that includes at least a portion of the apparatus signal identification area. Further, the signal receiving mechanism moves along an axis of movement. The identification apparatus further includes a control mechanism in communication with the signal receiving mechanism. The control mechanism controls the movement of the signal receiving mechanism along the axis of movement and/or receives, processes and/or transmits the signal received by the signal receiving mechanism.

The present invention is also directed to a method of receiving a signal from at least one of multiple identity source elements positioned in a signal identification area. This method includes the steps of: (a) moving a signal receiving mechanism along at least one axis of movement; (b) receiving a signal emitted by at least one of the plurality of identity source elements by the signal receiving mechanism; and (c) controlling the movement of the signal receiving mechanism by a control mechanism.

The present invention is further directed to an identification apparatus for use in connection with a plurality of discrete identity source elements positioned in an identification apparatus signal identification area. The identification apparatus includes a plurality of signal receiving mechanisms forming a first signal receiving module to receive a signal emitted from at least one of the plurality of identity source elements. Each of the plurality of signal receiving mechanisms has a respective field of detection, each of which comprises at least a portion of the identification apparatus signal identification area and at least partially overlaps another field of detection. Each signal receiving mechanism is individually powered in a specified pattern, and the first signal receiving module moves along at least one axis of movement. A control mechanism is in communication with the signal receiving module and: (i) controls activation of the plurality of signal receiving mechanisms; (ii) controls the movement of the first signal receiving module along the at least one axis of movement; and/or (iii) receives, processes, and transmits the signal received by the plurality of signal receiving mechanisms, or any combination thereof.

The present invention is further directed to an identification apparatus for use in connection with a plurality of discrete identity source elements positioned in an identification apparatus signal identification area. The identification apparatus includes a plurality of signal receiving mechanisms forming a signal receiving module to receive a signal emitted from at least one of the plurality of identity source elements. Each of the plurality of signal receiving mechanisms is formed on a respective surface area of the signal receiving module and has a respective field of detection. The signal receiving module is configured to rotate in at least one plane of movement and move along at least one axis of movement. A control mechanism is in communication with the signal receiving module and: (i) controls activation of the plurality of signal receiving mechanisms; (ii) controls the rotation of the signal receiving module in the at least one plane of movement; (iii) controls the movement of the signal receiving module along the at least one axis of movement; and/or (iv) receives, processes, and transmits the signal received by the plurality of signal receiving mechanisms, or any combination thereof.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

### BRIEF DESCRIPTION OF THE DRAWINGS

FIG. 1 is a schematic view of a radio frequency identification system according to the prior art;

FIG. 2 is a further schematic view of the prior art system of FIG. 1;

FIG. 3 is a schematic view of a multiple antenna identification system according to the prior art;

FIG. 4 is a schematic view of an identification apparatus according to the present invention;

FIG. 5 is a schematic view of a further embodiment of an identification apparatus according to the present invention;

FIG. 6 is a schematic view of the identification apparatus of FIG. 5 in use with a shelf arrangement; and

FIG. 7 is a schematic view of another embodiment of an identification apparatus according to the present invention.

### DESCRIPTION OF THE PREFERRED EMBODIMENTS

For purposes of the description hereinafter, the terms “upper”, “lower”, “right”, “left”, “vertical”, “horizontal”, “top”, “bottom” and derivatives thereof shall relate to the invention as it is oriented in the drawing figures. However, it is to be understood that the invention may assume various alternative variations and step sequences, except where expressly specified to the contrary. It is also to be understood that the specific devices and processes illustrated in the attached drawings, and described in the following specification, are simply exemplary embodiments of the invention. Hence, specific dimensions and other physical characteristics related to the embodiments disclosed herein are not to be considered as limiting.

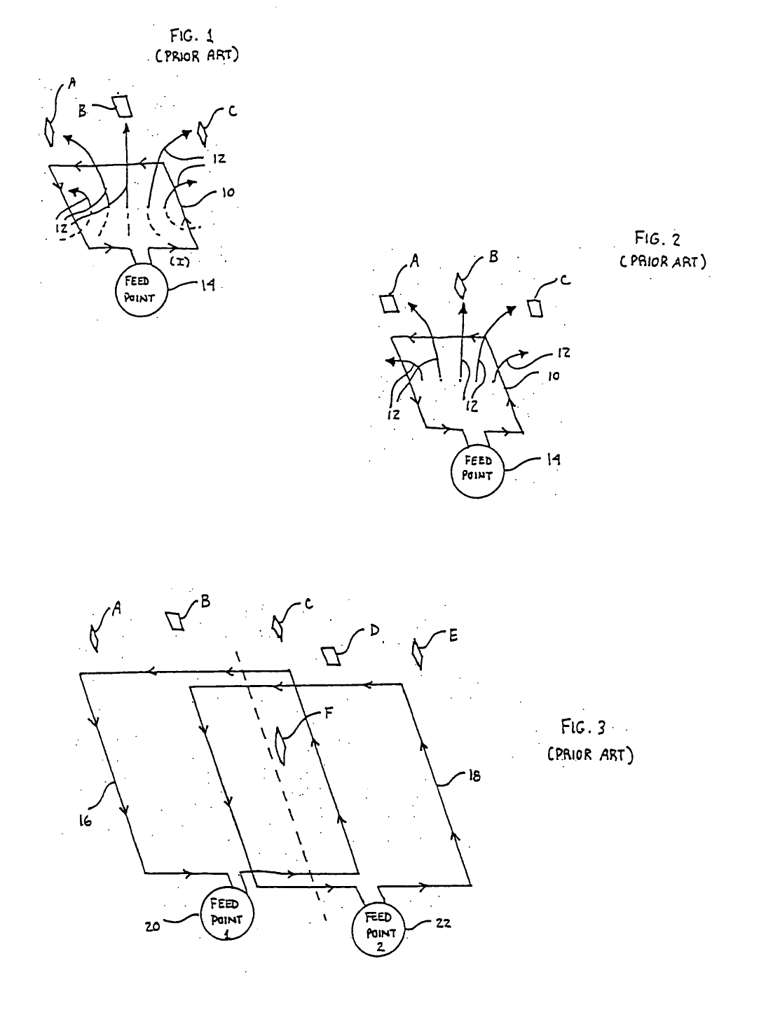

According to the prior art, as illustrated in FIGS. 1 and 2, an antenna 10 is used to project signals 12 that communicate with and power tags A, B and C. Current (I) is directed through the antenna 10 via a feed point 14. Further, the antenna 10 is a generally planar antenna, such that the signals 12 are emitted in the directions illustrated in FIGS. 1 and 2.

Specifically with respect to FIG. 1, when tags A, B and C are oriented as illustrated, the signals 12 are effectively communicated to the tags A, B and C, since the signals 12 are oriented transverse or substantially perpendicular to the face of the tags A, B and C. Therefore, when the tags A, B, C are oriented as shown in FIG. 1, the prior art system is effective, since the antenna 10 is capable of communicating with and identifying all of the tags A, B, C.

However, as seen in FIG. 2, when the tags A, B, C are oriented in a position ninety degrees with respect to the positioning in FIG. 1, the signals 12 from the antenna 10 cannot effectively read or identify tags A, B, C. Since it is the edge portion of tags A, B, C that the signal intercepts, effective and accurate reading is not possible. This means that if a person places an object (not shown) having the tag A, B, C attached thereto in such a position, the item or object would not be identified by this prior art system.

FIG. 3 illustrates one prior art solution that attempts to overcome this deficiency. In this system, tags A, B, C, D, E, F are placed at various positions in the antenna 10 field of detection (the area that the signals 12 are acting upon). This prior art system is a multiple antenna system, in this case having a first antenna 16 and a second antenna 18. The first antenna 16 and the second antenna 18 overlap and are powered through a first feed point 20 and a second feed point 22. In addition, a switching system (not shown) is used to move the location of the powering/communicating antenna from the first antenna 16 to the second antenna 18 and vice versa.

Since the first antenna 16 and the second antenna 18 are switching, tags A, B, C, D, E are identified by either the first antenna 16 or the second antenna 18. However, due to the powering of the antennae, their relative positioning and the location of the first antenna 16 and the second antenna 18 in the system, tag F would still not be read by either the first antenna 16 or the second antenna 18. Therefore, while such a multiple antenna system would certainly capture most of the tags, namely tags A-E, it would not pick up tag F, thereby making the system, while “mostly” accurate, not wholly so. Therefore, the need remains for the ability to pick up all tags A-F regardless of their relative positioning in the system and with respect to the antennae 10, 16, 18.

Accordingly, the present invention is an identification apparatus 100 for use in connection with multiple and discrete identity source elements 102, such as tags A-F. As discussed above, these tags A-F, or identity source elements 102, are typically connected to or in operative communication with an object or item 103 that is the object of identity. Further, the identity source elements 102 and corresponding items 103 are placed in an identification apparatus signal identification area. In one preferred and non-limiting embodiment, the object or item 103 is a medical item, a container of medicine, a medical device, a hospital-related item, etc. In addition, the signals emitted by the identity source elements 102 include a characteristic unique to either the item 103 or a group of related items 103. It is further envisioned that the identity source elements 102 can be tags or labels that are affixed to the item 103 and emit a unique signal corresponding to the item 103.

A signal receiving mechanism 104 emanates and receives a signal that is emitted from one or more of the identity source elements 102. In addition, the signal receiving mechanism 104 includes a field of detection that is in at least a portion of the identification apparatus signal identification area. Further, and as contemplated in the art, the signal receiving mechanism 104 is typically an antenna that is capable of transmitting and receiving signals and powering and communicating with the identity source elements 102, which are typically referred to as tags A-F. In addition, when the signal receiving mechanism 104 is an antenna, this antenna is capable of receiving radio frequency signals emitted from the identity source elements 102. Further, in this arrangement, the identity source elements 102 are radio frequency identification transponders.

As opposed to using multiple antennae 10, 16, 18 as in the prior art, the present invention and identification apparatus 100 uses a moving signal receiving mechanism 104. This means that the signal receiving mechanism 104 is able to move along at least one axis of movement (X, Y, Z). Further, a control mechanism 106 is in communication with the signal receiving mechanism 104 and is able to control the movement of the signal receiving mechanism 104 along the axis of movement (X, Y, Z). Further, it is also envisioned that the control mechanism 106 is capable of receiving, processing and/or transmitting the signals received by the signal receiving mechanism 104. It is also envisioned that the signal receiving mechanism 104 does not simply traverse one direction along the axis of movement (X, Y, Z), and instead moves back and forth along this axis at a standard period, rate or other parameter, as controlled through the control mechanism 106.

In order to power and provide current to the signal receiving mechanism 104, a feed mechanism 108 is used. Similarly, in order to move the signal receiving mechanism 104 along an axis of movement (X, Y, Z), a drive mechanism 110 is in operative communication with the signal receiving mechanism 104. The control mechanism 106 is therefore in communication with the drive mechanism 110, the signal receiving mechanism 104 and/or the feed mechanism 108. The control mechanism 106 provides a user of the identification apparatus 100 with optimal control over the system, the powering of the identity source elements 102, the communication between the signal receiving mechanism 104 and the identity source elements 102, the movement of the signal receiving mechanism 104, the operation of the signal receiving mechanism 104 and other similar variables and controllable components in the system.

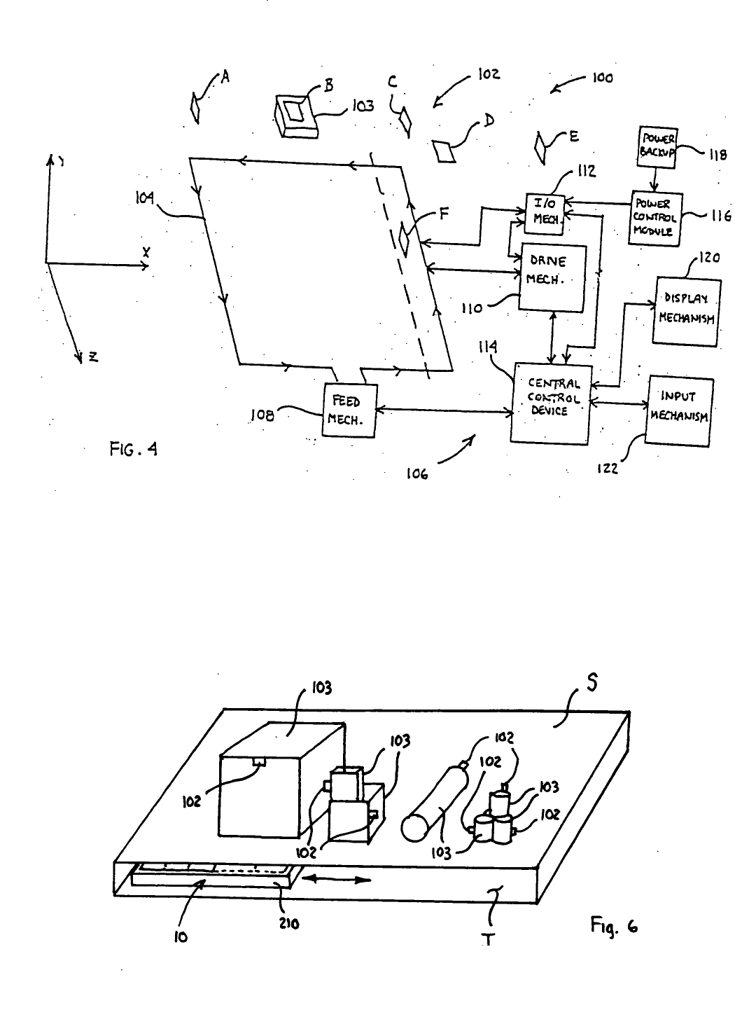

As seen in the preferred and non-limiting embodiment of FIG. 4, the signal receiving mechanism 104 moves in an axis of movement, namely the X-axis of movement. With reference to tags A-F, as shown in identical positions in both FIG. 3 (prior art) and FIG. 4, the signal receiving mechanism 104 will power, communicate with and receive signals from all of the identity source elements 102, namely all of tags A-F. This occurs since, while the signal receiving mechanism 104 may not pick up one or more of tags A-F in a first position as the signal receiving mechanism 104 moves back and forth across the axis of movement, the signals 12 emanating from the signal receiving mechanism 104 will appropriately contact, power and communicate with each identity source element 102 at at least one point in time. While the exemplary embodiment is showing the signal receiving mechanism 104 moving in the X-axis of movement, the signal receiving mechanism 104 may also move in various axes of movement, such as the Y-axis and the Z-axis. In addition, multiple signal receiving mechanisms 104 may be used and provide further areas of detection.

Since the signal receiving mechanism 104 is moving, the signal receiving mechanism field of detection moves through the entire identification apparatus signal identification area in a dynamic manner, whereby each and every identification source element 102 is identified. The drive mechanism 110 may be a mechanical motor or other similar device. The result of the movement of the signal receiving mechanism 104 is equivalent to an infinite number of switchable antennae, as described in connection with FIG. 3 of the prior art. Therefore, the present invention provides an identification apparatus 100 that reduces the complexity of the overall system, while increasing the overall accuracy.

In a preferred and non-limiting embodiment, the drive mechanism 110 is a stepper motor, which moves the signal receiving mechanism 104 along a single axis of movement. However, as discussed above, motion along other axes may be provided to provide a three-dimensional result or a second and third antenna can be added to provide powering/communication in these directions. When using multiple signal-receiving mechanisms 104, the control mechanism 106 is capable of selecting the appropriate pairs and otherwise operating all signal-receiving mechanisms 104 in the identification apparatus 100.

In another preferred and non-limiting embodiment, the control mechanism 106 may also include an input/output mechanism 112 that is in communication with the signal receiving mechanism 104 and translates one or more output signals into digital output signals. In addition, in this embodiment, the control mechanism 106 also includes a central control device 114 in communication with the input/output mechanism 112. The central control device 114 receives, processes and otherwise transmits signals for initiating actions based upon the digital output signal received from the input/output mechanism 112. Further, the control mechanism 106 may also include a power control module 116 that is in communication with the input/output mechanism 112 and provides specified power outputs at specified power levels. In the event of electronic power failure, a backup power module 118 may also be included. As with the power control module 116, the backup power module 118 would be in communication with the input/output mechanism 112 for supplying power in emergency situations.

The central control device 114 may be a programmable microchip, a microcontroller, a personal computer, a hand-held computer, a terminal, a networked computing device, etc. The central control device 114 and/or the control mechanism 106 may also include a control program for receiving, processing and transmitting signals initiating actions based upon signal content. It is further envisioned that the control mechanism 106 may be integral with or in communication with a display mechanism 120. The display mechanism 120 provides a visual display to the user. For example, the visual display may illustrate or otherwise visually inform the user of initiated action, a use history, an item 103 history, a user history, user data, identity source element 102 data, inventory data, item 103 data, identification apparatus 100 data, etc. In order to communicate with the control mechanism 106 and/or the central control device 114, an input mechanism 122 may also be included. The input mechanism 122 receives user input and transmits user input signals to the control mechanism 106 and/or the central control device 114.

It should also be noted that any or all of the feed mechanism 108, input/output mechanism 112, power control module 116, power backup 118, display mechanism 120 and input mechanism 122 may be in communication, both hardwired and wireless, with the central control device 114. In addition, these various components and sub-components are collectively referred to as the control mechanism 106 and may be integrated therewith or stand-alone equipment. For example, in the case of the display mechanism 120, this display mechanism 120 may be a monitor and, for example, the input mechanism 122 may be a keyboard. Still further, all of the components and equipment can be integrated into a single unit or housing and operate as a unified system.

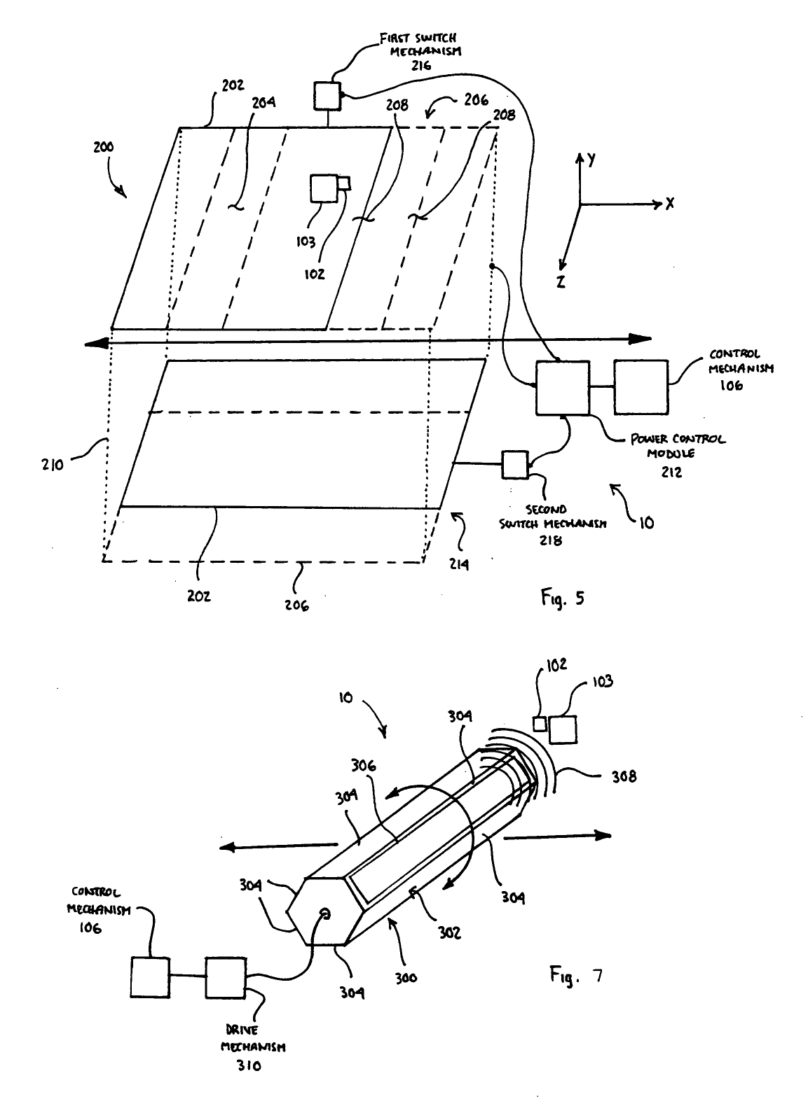

In another preferred and non-limiting embodiment, the identification apparatus 10 includes a first signal receiving module 200, and this first signal receiving module 200 includes a first signal receiving mechanism 202, such as an antenna loop, which is positioned in a plane and configured to emit a signal in a first field of detection 204. In addition, the first signal receiving module 200 includes at least one additional signal receiving mechanism 206, which is positioned substantially in the same plane as the first signal receiving mechanism 202. Further, as with the first signal receiving mechanism 202, the additional signal receiving mechanism 206 is configured to emit a signal in an additional field of detection 208. Still further, the first field of detection 204 and the additional field of detection 208 at least partially overlap. Both the first signal receiving mechanism 202 and the additional signal receiving mechanism 206 may be positioned on a common and substantially planar substrate 210 (which is exaggerated in spacing for purposes of clarity in FIG. 5). It is this substrate 210 which may be moveable along the at least one axis of movement, as controlled by the control mechanism 106.

In order to emit a signal or field, the first signal receiving mechanism 202 and the additional signal receiving mechanism 206 are in operative communication with and powered by a power control module 212. In particular, the power control module 212 provides current to the signal receiving mechanisms 202, 206, causing them to emanate a signal or field and, thereby, activate the identity source element 102 attached to the item 103.

Due to the overlapping signal receiving mechanisms 202, 206 and, consequently, fields of detection 204, 208, the resulting coverage of the field or signal emitted from the signal receiving mechanisms 202, 206 is maximized. In addition, the signal receiving mechanisms 202, 206 are “activated” or “powered” according to a specified pattern. For example, in one embodiment, the first signal receiving mechanism 202 is activated and obtains signals from identity source elements 102 within its first field of detection 204, and subsequently and serially, the additional signal receiving mechanism 206 is activated and receives signals from the identity source elements 102 in the additional field of detection 208. Since the first field of detection 204 and additional field of detection 208 overlap, the identity source elements 102 that are placed in a “dead spot” or low probability reading area in one of these fields 204, 208, are read or identified due to its relative position in the other field of detection 204, 208. In the illustrated embodiment, the first signal receiving module 200 utilizes three signal receiving mechanisms (i.e., the first signal receiving mechanism 202 and two additional signal receiving mechanisms 206). Any number of such signal receiving mechanisms 202, 206 may be used.

In order to more effectively identify identity source elements 102, a second signal receiving module 214 could be utilized. This second signal receiving module 214 (together with the first signal receiving module 200) is illustrated in FIG. 5. In particular, the second signal receiving module 214 includes multiple signal receiving mechanisms (or antenna loops) that are arranged and interact as discussed above in connection with the first signal receiving module 200. However, the second signal receiving module 214, and specifically the signal receiving mechanisms of the second signal receiving module 214, are positioned substantially in the same plane as and oriented at about 90 degrees with respect to the first signal receiving module 200. Accordingly, the second signal receiving module 214 can be placed on, near, adjacent or in operative communication with the substrate 210, but the orientation is rotated 90 degrees with respect to the first signal receiving module 200. Further, the first signal receiving module 200 and the second signal receiving module 214 may be in a stacked relationship, such that the first signal receiving module 200 and the second signal receiving module 214 are substantially immediately adjacent each other. However, it is envisioned the second signal receiving module 214 could be co-planar with and spaced from the first signal receiving module 200.

Due to the orientation of the first signal receiving module 200 and second signal receiving module 214 with respect to each other, namely 90 degree rotation, and due to the resulting rotation of the fields projected from the signal receiving mechanisms, a three-dimensional magnetic field is created. Using the second signal receiving module 214, all of the identity source elements 102 (or transponders) having the Y-X orientation are identified. Accordingly, without using specifically oriented cube-type complex antenna systems and arrangements, the use of the 90-degree orientation between the first signal receiving module 200 and the second signal receiving module 214 achieves the same three-dimensional effect to recognize any identity source element 102 (and therefore, any item 103) in the system.

Still further, by moving the first signal receiving module 200 and second signal receiving module 214 (on the substrate 210) along the axis of movement, a much greater area is covered for identifying identity source elements 102. Therefore, as opposed to using multiple signal receiving modules 200, 214, each set on a substrate 210, the substrate 210 can be motivated back and forth along a much greater area. This would allow the identification apparatus 10 to traverse great distances of any geometry and size, and conduct the appropriate “read” of the identity source elements 102, and therefore, items 103. Accordingly, the three-dimensional effect obtained from the stacked, rotated signal receiving modules 200, 214, could be used to improve accuracy and effectiveness in a variety of situations, applications and environments.

It is envisioned that one of the plurality of signal receiving mechanisms of each signal receiving module 200, 214 are activated or switched “ON” at the same time. This allows the control mechanism 106 to much more quickly identify the identity source elements 102 that the antennae are capable of identifying. Any number of patterns is envisioned for activation of the antennae of the signal receiving modules 200, 214. However, the activation sequence or pattern should be adjusted to ensure that none of the magnetic fields generated by the antennae cancel each other out or have any other negative effects on the identification properties and characteristics of the present invention.

In this embodiment, in order to power the signal receiving mechanisms 202, 206 in the appropriate sequence, the power control module 212 is in communication with a first switch mechanism 216 and a second switch mechanism 218. Each switch mechanism 216, 218 is in communication with the signal receiving mechanisms 202, 206 and serve to activate or “power” the loops in the desired pattern. Further, it is envisioned that matching circuits and other known mechanisms and controllers could be used to ensure that the signal receiving mechanisms 202, 206 and/or signal receiving modules 200, 214 are activated appropriately.

The above-discussed dual-signal receiving module arrangement can be effectively used in a variety of applications. For example, as illustrated in FIG. 6, the identification apparatus 10 of this embodiment could be placed in an interior area I of a shelf S. The items 103 (and attached identity source elements 102) could be placed on a top surface of the shelf S, and the apparatus 10 would move along the axis of movement in the interior area I. In this manner, the identity source elements 102 could be easily “read”, regardless of orientation on the shelf S, or size, position and orientation of the item 103 (or identity source element 102 connected thereto). Of course, the identification apparatus 10 could also be placed in an interior area of a wall of a cabinet or container as well. Still further, multiple identification apparatuses 10 could be used in any number of surrounding surfaces, walls, etc. of an enclosed area.

A further and non-limiting embodiment is illustrated in FIG. 7. In this embodiment, the signal receiving module 300 is in the form of an elongated element or tube 302. It is envisioned that the cross section of the elongated element 302 may be substantially tubular, polygonal, square or circular. Further, the elongated element 302 itself may be in the form of signal receiving mechanism or antenna (e.g., a dipole antenna element or wire), or alternatively, the elongated element 302 may include multiple surfaces 304. In the multi-surface arrangement, a signal receiving mechanism 306 may be disposed or positioned on each surface 304. Regardless, the elongated element 302 (or signal receiving module 300) is rotatable in a plane of rotation. Still further, the elongated element 302 is moveable along the at least one axis of movement.

In operation, the rotation of the elongated element 302 will serve to rotate the signal receiving mechanisms 306 (or, as discussed above, the elongated element 302 itself may be the signal receiving element), and thereby rotate the field of detection 308 in an angular manner. Therefore, the field of detection 308 will be constantly rotated at a different angle and will be capable of much more effectively “reading” the identity source elements 102. The rotation of the elongated element 302 can be controlled by the control mechanism 106. This arrangement provides an antenna that is moving along the axis of movement, as well as rotating the angle of the field of detection 308 in the plane of rotation, which results in increased accuracy and effectiveness.

In addition, a drive mechanism 310, such as the same drive mechanism 110 discussed above, is utilized to rotate the elongated element 302 in the plane of rotation. Further, this drive mechanism 310 could be used to move the elongated element 302 along the axis of movement. Accordingly, the control mechanism 106 may be in communication with the drive mechanism 310. It is also envisioned that the signal receiving mechanism 306 be replaced with the dual-signal receiving module arrangement discussed above, in which case the arrangement would be placed on some, a portion of, or all of the surfaces 304 of the elongated element 302. Still further, multiple moving elongated elements 302 could be used to effectively cover a greater area and provide more accurate “reads” of the identity source elements 102.

In this manner, the present invention provides an identification apparatus 100 that provides powering/communicating capabilities with identity source element 102, such as an RF/ID tag, regardless of the tag orientation with respect to the antennae. In addition, the present invention provides the realization of three-dimensional tag placement without the need for a large number of antennae. Still further, the present invention provides an identification apparatus 100 that represents an infinite number of discrete antennae and provides increased accuracy by interrogating different tags in their optimal positions at different times. In turn, this allows an increase in the number of identity source elements 102 (and, therefore, the objects to which they are attached) read per area and a decrease in the required space between the identity source elements 102. In addition, the present invention provides an identification apparatus 100 that is less complicated in control, in its electronics usage and is easily tuned.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

The invention claimed is:

1. An identification apparatus for use in connection with a plurality of discrete identity source elements positioned in an identification apparatus signal identification area, the identification apparatus comprising:
a plurality of signal receiving mechanisms forming a first signal receiving module and configured to receive a signal emitted from at least one of the plurality of identity source elements, each of the plurality of signal receiving mechanisms having a respective field of detection, each of which comprises at least a portion of the identification apparatus signal identification area and at least partially overlaps another field of detection, wherein each signal receiving mechanism is configured to be individually powered in a specified pattern, and wherein the first signal receiving module is configured to move along at least one axis of movement; and
a control mechanism in communication with the signal receiving module and configured to: (i) control activation of the plurality of signal receiving mechanisms; (ii) control the movement of the first signal receiving module along the at least one axis of movement; (iii) receive, process, and transmit the signal received by the plurality of signal receiving mechanisms, or any combination thereof.

2. The apparatus of claim 1, further comprising a power control module in communication with the signal receiving module and configured to provide current thereto.

3. The apparatus of claim 1, wherein the pattern is a sequential and serial pattern.

4. The apparatus of claim 1, further comprising a plurality of signal receiving mechanisms forming a second signal receiving module and configured to receive a signal emitted from at least one of the plurality of identity source elements, each of the plurality of signal receiving mechanisms having a respective field of detection, each of which comprises at least a portion of the identification apparatus signal identification area and at least partially overlaps another field of detection, wherein each signal receiving mechanism is configured to be individually powered in a specified pattern, and wherein the second signal receiving module is configured to move along the at least one axis of movement.

5. The apparatus of claim 4, wherein the second signal receiving module is aligned with, positioned substantially in the same plane as and oriented at about 90° with respect to the first signal receiving module.

6. The apparatus of claim 4, wherein the first signal receiving module and the second signal receiving module are in a stacked relationship, such that the first signal receiving module and the second signal receiving module are substantially immediately adjacent with each other.

7. The apparatus of claim 4, wherein the second signal receiving module is coplanar with and spaced from the first signal receiving module.

8. The apparatus of claim 4, wherein the first signal receiving module and the second signal receiving module are positioned on a single, substantially planar substrate, which is configured to move along the at least one axis of movement.

9. The apparatus of claim 4, wherein at least one signal receiving mechanism of the first signal receiving module and at least one signal receiving mechanism of the second signal receiving module are power substantially simultaneously.

10. The apparatus of claim 1, wherein the signal receiving mechanism is an antenna configured to receive radio frequency signals emitted from the identity source elements, and wherein the identity source elements are radio frequency identification transponders.

11. The apparatus of claim 1, wherein at least one of the identity source elements is in operative communication with at least one item positioned in the identification apparatus signal identification area.

12. The apparatus of claim 1, wherein the control mechanism further comprises:
an input/output mechanism in communication with the signal receiving mechanism and configured to translate at least one output signal into at least one digital output signal; and
a central control device in communication with the input/output mechanism and configured to receive, process and transmit signals and initiate an action based upon the at least one digital output signal received from the input/output mechanism.

13. The apparatus of claim 1, wherein the identity source elements are at least one of tags and labels affixed to at least one item and configured to emit a unique signal corresponding to the at least one item.

14. The apparatus of claim 1, further comprising a drive mechanism configured to move the first signal receiving module along the at least one axis of movement.

15. The apparatus of claim 14, wherein the drive mechanism motivates the first signal receiving module to move back and forth along the at least one axis of movement, the operation of the drive mechanism controlled by the control mechanism.

16. An identification apparatus for use in connection with a plurality of discrete identity source elements positioned in an identification apparatus signal identification area, the identification apparatus comprising:
a plurality of signal receiving mechanisms forming a signal receiving module and configured to receive a signal emitted from at least one of the plurality of identity source elements, each of the plurality of signal receiving mechanisms formed on a respective surface area of the signal receiving module and having a respective field of detection, wherein the signal receiving module is configured to rotate in at least one plane of movement and move along at least one axis of movement; and
a control mechanism in communication with the signal receiving module and configured to: (i) control activation of the plurality of signal receiving mechanisms; (ii) control the rotation of the signal receiving module in the at least one plane of movement; (iii) control the movement of the signal receiving module along the at least one axis of movement;
(iv) receive, process, and transmit the signal received by the plurality of signal receiving mechanisms, or any combination thereof.

17. The apparatus of claim 16, wherein the signal receiving mechanism is an antenna configured to receive radio frequency signals emitted from the identity source elements, and wherein the identity source elements are radio frequency identification transponders.

18. The apparatus of claim 16, further comprising a drive mechanism configured to rotate and move the signal receiving module.

19. The apparatus of claim 18, wherein the drive mechanism motivates the signal receiving module to move back and forth along the at least one axis of movement, the operation of the drive mechanism controlled by the control mechanism.

20. The apparatus of claim 16, wherein the signal receiving module has at least one of a substantially tubular, substantially polygonal, substantially square or substantially circular cross section.
